(19) United States
(12) Patent Application Publication
(10) Pub. No.: US 2020/0285197 A1
(43) Pub. Date: Sep. 10, 2020

(54) Mirror image time piece

(71) Applicant: James Anzai Castillo, Honolulu, HI (US)

(72) Inventor: James Anazi Castillo, Honolulu, HI (US)

(21) Appl. No.: 16/501,238

(22) Filed: Mar. 7, 2019

(51) Int. Cl. G04B 19/06; G04B 19/24

(52) U.S. Cl. CPC G04B 19/06; G04B 19/24

(57) ABSTRACT

A “mirror imaged” timepiece that is to be adorned (worn) on the human body, such that when viewed through a reflecting mirror, will be viewed and observed in its correct proper perspective. This will allow the creation of timepieces to be worn on new areas of the body where previously it was not feasible, because the wearer would have had difficulty viewing these timepieces in its correct perspective on these certain difficult to view areas of the human body. Timepieces such as broach timepieces, pendant timepieces, earring timepieces, choker timepieces, headband timepieces, upper arm timepieces, tie clip timepieces, lapel pin timepieces, and etc. were not feasible because the wearer would not be able to view them in its proper perspective without difficulty. The present invention allows the creation of timepieces that can be worn on new areas of the human body where they were not feasible before, because now with the present invention the wearer will be able to view the “Mirror Image Timepiece” easily, in its correct proper perspective, through either a hand-held mirror, a wall positioned mirror, or any other reflective surface, when adorned on these difficult to view areas of the human body.

### BACKGROUND OF THE INVENTION

### Field of Invention

The present invention relates to a “mirror imaged” or “perspective inverted” time indicating device, more particularly, a timepiece that is to be adorned (worn) on the human body, such as a broach watch, a pendant watch, a choker watch, an earring watch, a tie-pin watch, a lapel watch, or any other timepiece that can be adorned (worn) on the human body, that when viewed through a reflecting mirror, we be viewed and observed in its correct proper perspective. This will allow manufacturers of timepieces to create new and novel timepieces to be adorned on parts of the human body that was previously not feasible because the wearer would not be able to easily view the timepieces that were designed to be worn on these difficult to view areas of the human body. Whereas, if the broach timepieces, pendant timepieces, earring timepieces, choker timepieces, headband timepieces, upper arm timepieces, and etc. were “Mirror Image Time Pieces” or ‘Perspective Inverted’, then the wearer will be able to view them easily in its correct proper perspective, through either a hand-held mirror, or a wall positioned mirror, or any other reflecting surface.

### BRIEF SUMMARY OF THE INVENTION

Present timepieces to be worn on the human body are usually limited to wristwatches, and pocket watches. This is because if timepieces are worn on other parts of the body as a broach, or as a choker, or earring, or as a tie pin or lapel pin, it will be difficult for the wearer to view the time. This invention provides a means to create new timepieces that can be adorned (worn) elsewhere on the human body, where timepieces were not feasible due to the difficulty of viewing the face of the timepiece when worn in these areas of the human body. This invention, the “Mirror Image Timepiece”, departs and overcomes the disadvantages and limitations inherent in present day timepieces to be adorned on certain parts of the human body as follows:

a) it allows for the creation of new novel timepieces designed to be worn elsewhere on the human body such as on the forehead as a headband, on the neck as a choker, on the neck as a pendant, on the ears as an earring, on a tie as a tie-pin, on the lapel of a jacket as a pin, on the front of the upper arm as an arm band, and etc. that can be viewed in its proper perspective through the use of a hand-held mirror, a wall mounted mirror, a vehicle rear-view mirror, or any other reflecting surface.

b) it allows for creation of new combination products, such as a matching timepiece and mirror set as a new fashion accessory.

c) it will also provide a means for physically handicapped/challenged individuals (individuals without arms and/or individuals with paralysis who have difficulty moving their arms to a position that he/she can view his/her wristwatch with ease, with a timepiece that can be worn elsewhere on the body where the timepiece can be now viewed by these individuals with more ease through the use of a mirror or reflecting surface.

### BRIEF DESCRIPTION OF THE DRAWINGS

FIG. 1 is a perspective view of a person using a hand-held mirror and looking at the ‘Mirror Image Timepiece’ through this hand-held mirror according to the present invention, and viewing the ‘Mirror Image Timepiece’ in its correct perspective through this mirror.

FIG. 2 is a frontal view of the present ‘Mirror Image Timepiece’ invention in the form of a broach or pendant,

FIG. 3 indicates the actual ‘Counter Clockwise’ direction of the movement of the Hour Hand, the Minute Hand, and the Second Hand of the ‘Mirror Image Timepieces’ in FIG. 2, FIG. 4, and FIG. 5.

FIG. 4 is a frontal view of still another version of the present ‘Mirror Image Timepiece’ invention in the form and style of a headband, choker, or upper arm band,

FIG. 5 is a frontal view of still another version of the present ‘Mirror Image Timepiece’ invention, in the form and style of a lapel pin or tie clip,

FIG. 6 is a frontal view of Timepiece detailed in FIG. 2, in its correct perspective, when viewed through a mirror or other reflective surface,

FIG. 7 indicates the ‘Clockwise’ direction of the movement of the Hour Hand, the Minute Hand, and the Second Hand of the Timepieces in FIG. 6, FIG. 8, and FIG. 9, when the ‘Mirror Image Timepiece’ is viewed through a mirror or other reflective surface,

FIG. 8 is a frontal view of Timepiece detailed in FIG. 4, in its correct perspective, when viewed through a mirror or other reflective surface,

FIG. 9 is a frontal view of Timepiece detailed in FIG. 5, in its correct perspective, when viewed through a mirror or other reflective surface.

### DETAILED DESCRIPTION OF THE INVENTION

It is the intention of this invention to overcome the disadvantages of the difficulties encountered in the viewing of present timepieces when adorned (worn) on certain areas of the human body.

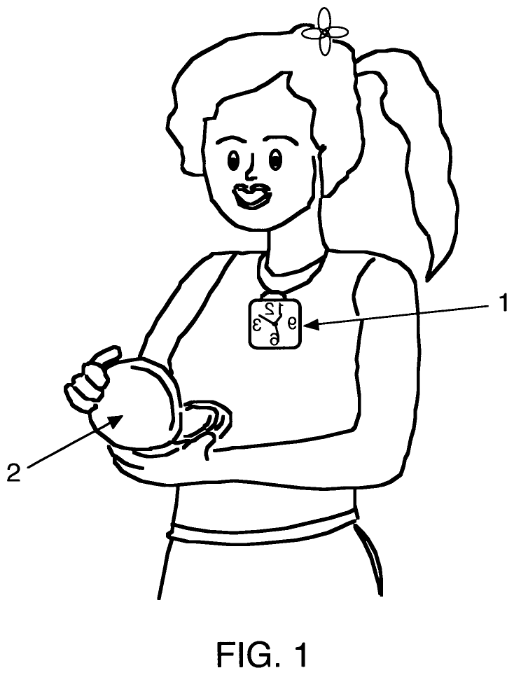

The Mirror Image Timepiece 1 in FIG. 1, is a Pendant style ‘Mirror Image Timepiece’ worn by this women. She is viewing her Pendant style ‘Mirror Image Timepiece’ through her ‘Handheld Mirror’ 2 in FIG. 1.

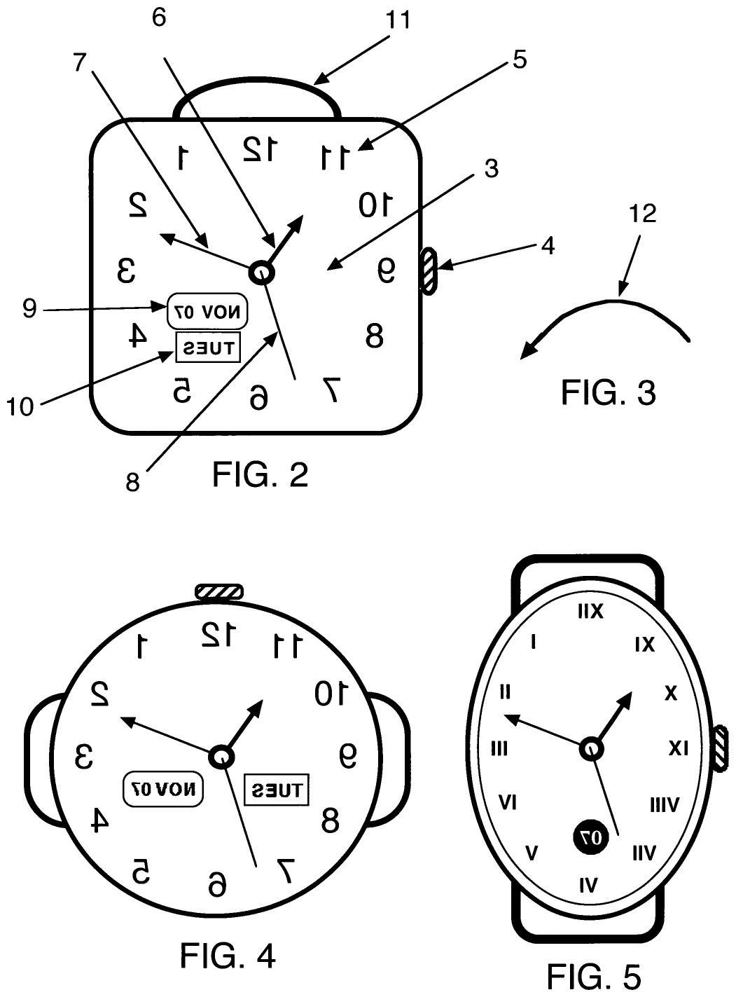

FIG. 2 details the Frontal Direct View of a ‘Mirror Image Timepiece’ suited for a broach or pendant, which is adorned by the women in FIG. 1, where 3 is the face of the timepiece, where 4 is the time/date/weekday adjusting knob, where 5 are the numerical time indicators (1˜12) on the face of the ‘Mirror Image Timepiece’, where 6 is the hour hand, where 7 is the minute hand, where 8 is the second hand, where 9 is the month/date indicator, where 10 is the weekday indicator, and where 11 is the bracket, handle, or hook that provides a means to attach the timepiece to a band, rope, pin, or chain so that the timepiece can be adorned on the human body.

FIG. 3 arrow 12 indicates the actual ‘Counter Clockwise’ direction of the movement of, 6 the Hour Hand, 7 the Minute Hand, and 8 the Second Hand of Timepieces detailed in FIG. 2, and consequently for timepieces detailed in FIG. 4 and FIG. 5 also.

FIG. 4 details the Frontal Direct View of still another style of a ‘Mirror Image Timepiece’, suited for a Choker, Headband, or Armband.

FIG. 5 details the Frontal Direct View of still another style of a ‘Mirror Image Timepiece’, suited for a Lapel Pin or Tie Clip.

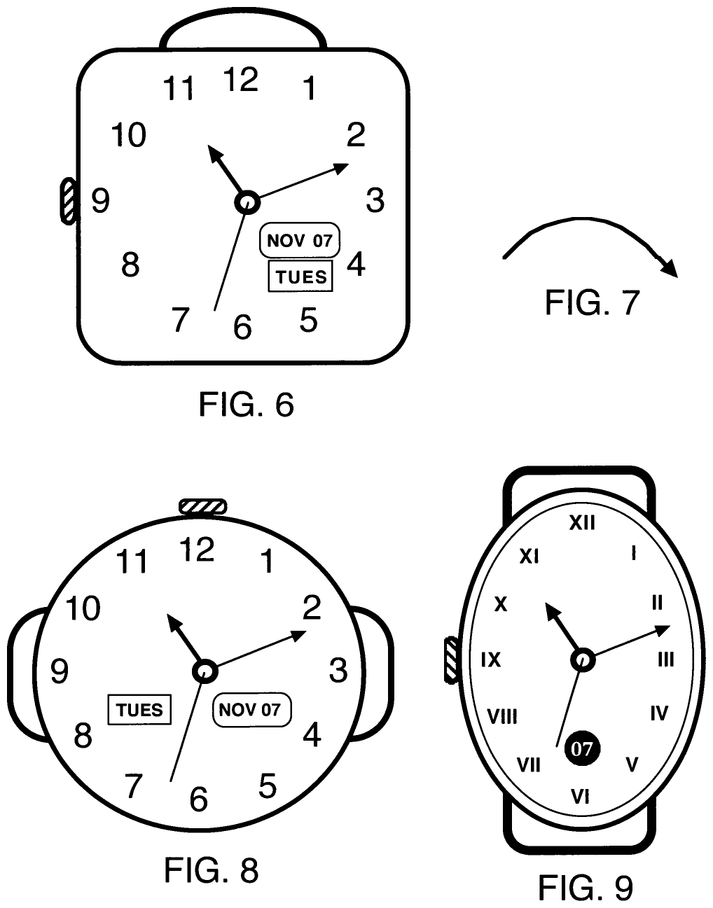

FIG. 6 depicts the correct perspective view of the ‘Mirror Image Timepiece’ detailed in FIG. 2, when viewed through a mirror or other reflective surface.

FIG. 7 indicates the ‘Clockwise’ direction of the movement of, the Hour Hand, the Minute Hand, and the Second Hand of Timepieces, when the ‘Mirror Image Timepieces’ detailed in FIG. 2, FIG. 4 and FIG. 5 are viewed through a mirror or other reflective surface.

FIG. 8 depicts the correct perspective view of the ‘Mirror Image Timepiece’ detailed in FIG. 4, when viewed through a mirror or other reflective surface.

FIG. 9 depicts the correct perspective view of the ‘Mirror Image Timepiece’ detailed in FIG. 5, when viewed through a mirror or other reflective surface.

What is claimed is:

1. A time indicating device, or timepiece, designed to be adorned (worn) on the human body, that is ‘Mirror Imaged’ or ‘Mirror Inverted’, in which said timepiece, is intended to be viewed in its correct perspective by the wearer, by viewing the timepiece through a mirror, or any other reflective surface, said time piece comprising of:
a case, with an analog drive means mounted within said case,
a face having a center, mounted in said case, and said face having a display of numbers (1˜12) distributed around the perimeter of the face for displaying numerically, the analog time information representative of twelve hours, in which the numerical numbers are ‘Mirror Imaged’ or ‘Mirror Inverted’,
a set of hour, minute, and second hands mounted and coupled to and driven around said center, by said drive, to move the hour, minute, and second hands in a counter-clockwise direction, to indicate the time,
a bracket, handle, or hook to provide a means to attached said timepiece to a band, rope, pin, or chain, whereby providing a means to secure said timepiece on the human body, or on a piece of clothing being worn by the individual,

2. A time indicating device, according to claim 1, wherein a see-through window is created on the said face of the timepiece to display the month alphabetically, wherein this alphabetical month display is ‘Mirror Imaged’ or Mirror Inverted’,

3. A time indicating device, according to claim 1, wherein a see-through window is created on the said face of the timepiece to display the day of the month numerically, wherein this numerical day of the month display is ‘Mirror Imaged’ or Mirror Inverted’,

4. A time indicating device, according to claim 1, wherein a see-through window is created on the said face of the timepiece to display the day of the week alphabetically, wherein this alphabetical day of the week display is ‘Mirror Imaged’ or Mirror Inverted’.
